(19) United States
(12) Patent Application Publication
(10) Pub. No.: US 2020/0348572 A1
(43) Pub. Date: Nov. 5, 2020

(54) LIQUID CRYSTAL DISPLAY

(71) Applicant: Samsung Display Co., Ltd., Yongin-si (KR)

(72) Inventors: Se Hyun LEE, Hwaseong-si (KR); Hae Chan PARK, Seoul (KR); Min Gyeong SHIN, Hwaseong-si (KR); Hui Gyeong YUN, Hwaseong-si (KR); Seung Min LEE, Seoul (KR); Hak Sun CHANG, Yongin-si (KR)

(21) Appl. No.: 16/813,586

(22) Filed: Mar. 9, 2020

(30) Foreign Application Priority Data
May 2, 2019 (KR) 10-2019-0051463

(51) Int. Cl. G02F 1/1362; G02F 1/1343; G02F 1/1368

(52) U.S. Cl. CPC G02F 1/136286; G02F 1/134336; G02F 1/13624; G02F 2001/134345; G02F 1/136209; G02F 2001/136222; G02F 1/1368

(57) ABSTRACT

A liquid crystal display includes: a plurality of pixel electrodes; and a first data line and a second data line, each of the first data line and the second data line configured to transmit a data voltage and having substantially straight and angled portions. The first data line and the second data line are adjacent to each other in a first direction. The plurality of pixel electrodes includes: a first pixel electrode that overlaps both the first data line and the second data line; and a second pixel electrode disposed adjacent to the first pixel electrode in a second direction that intersects the first direction without overlapping the first data line and the second data line.

### CROSS-REFERENCE TO RELATED APPLICATION

This application claims priority from and the benefit of Korean Patent Application No. 10-2019-0051463, filed on May 2, 2019, which is hereby incorporated by reference for all purposes as if fully set forth herein.

### BACKGROUND

### Field

Exemplary implementations of the invention relate generally to a liquid crystal display and, more specifically, to a liquid crystal display having a plurality of pixel electrodes electrically connected to data lines.

### Discussion of the Background

As one of the most widely used display devices, a liquid crystal display includes a liquid crystal layer including liquid crystal molecules, field generating electrodes that control alignment of the liquid crystal molecules of the liquid crystal layer, and a plurality of signal lines for application of a voltage to the field generating electrodes. When a voltage is applied to the field generating electrodes, an electric field is generated in the liquid crystal layer such that the liquid crystal molecules are re-aligned, and accordingly, a desired image can be displayed by adjusting the amount of transmitted light.

The field generating electrodes include a pixel electrode receiving a data voltage and a common electrode receiving a common voltage. The pixel electrode may receive the data voltage through a switch such as a transistor.

Liquid crystal displays may include sub-pixel structures to help improve visibility from the sides of the display.

The above information disclosed in this Background section is only for understanding of the background of the inventive concepts, and, therefore, it may contain information that does not constitute prior art.

### SUMMARY

Applicant discovered the liquid crystal display with sub-pixel structures are subject to staining due to differences in luminance that causes degradation in image quality or reliability.

Liquid crystal displays constructed according to the principles and exemplary implementations of the invention have sub-pixel structures that improve side visibility and are capable of displaying images with improved quality and/or reliability. For example, exemplary embodiments of the liquid crystal display of the invention include a data line overlapping a portion of pixel electrodes to reduce or prevent a stain (luminance difference) from being generated due to vertical crosstalk between the pixel electrodes and the data line.

Liquid crystal displays constructed according to principles and exemplary implementation of the invention have improved side visibility by preventing grayscale inversion from occurring at the side of the liquid crystal display and improved aperture ratio and transmittance.

Additional features of the inventive concepts will be set forth in the description which follows, and in part will be apparent from the description, or may be learned by practice of the inventive concepts.

According to one or more embodiments, a liquid crystal display includes: a plurality of pixel electrodes; and a first data line and a second data line, each of the first data line and the second data line configured to transmit a data voltage and having substantially straight and angled portions. The first data line and the second data line are adjacent to each other in a first direction. The plurality of pixel electrodes includes: a first pixel electrode that overlaps both the first data line and the second data line; and a second pixel electrode disposed adjacent to the first pixel electrode in a second direction that intersects the first direction without overlapping the first data line and the second data line.

The liquid crystal display may further include a third data line adjacent to the second data line in the first direction, wherein the plurality of pixel electrodes further includes a third pixel electrode disposed adjacent to the first pixel electrode in the first direction without overlapping any of the first data line, the second data line, and the third data line.

The plurality of pixel electrodes may further include a fourth pixel electrode adjacent to the second pixel electrode in the first direction and adjacent to the third pixel electrode in the second direction, and wherein the fourth pixel electrode overlaps both the second data line and the third data line.

Each of the first pixel electrode, the second pixel electrode, the third pixel electrode, and the fourth pixel electrode may include: a first subpixel electrode connected with a first transistor; and a second subpixel electrode connected with a second transistor and a third transistor, and wherein the second data line extends in the second direction between the first subpixel electrode of the first pixel electrode and the first subpixel electrode of the third pixel electrode, and may be angled to overlap second subpixel electrode of the first pixel electrode.

The second data line may extend in the second direction between the first subpixel electrode of the second pixel electrode and the first subpixel electrode of the fourth pixel electrode, and be angled to overlap the second subpixel electrode of the fourth pixel electrode.

The third data line may extend in the second direction while overlapping the second subpixel electrode of the fourth pixel electrode.

The liquid crystal display may further include: a common voltage line that extends in the first direction and transmits a common voltage; and a reference voltage line that extends in the first direction and transmits a reference voltage. the reference voltage line may be connected with the third transistor.

The liquid crystal display may further include a blocking layer that extends in the second direction between the second subpixel electrode of the first pixel electrode and the second subpixel electrode of the third pixel electrode. The common voltage line may include a vertical portion extending in the second direction between the first subpixel electrode of the first pixel electrode and the first subpixel electrode of the third pixel electrode and not between the second subpixel electrode of the first pixel electrode and the second subpixel electrode of the third pixel electrode.

The blocking layer may be electrically floated.

The blocking layer may be electrically connected with the reference voltage line and receives the reference voltage.

The liquid crystal display may further include a first color filter that overlaps the first pixel electrode and a second color filter that overlaps the third pixel electrode, wherein the blocking layer overlaps an area where the first color filter and the second color filter overlap each other, and wherein a width of the blocking layer is wider than a width of the area where the first color filter and the second color filter overlap each other.

The common voltage line may include a vertical portion extending in the second direction, and the vertical portion of the common voltage line may be disposed between the second subpixel electrode of the first pixel and the second subpixel electrode of the third pixel electrode.

The first data line may be electrically connected with the first subpixel electrode and the second subpixel electrode of the first pixel electrode, and the second data line may be electrically connected with the first subpixel electrode and the second subpixel electrode of the third pixel electrode.

The second data line may be electrically connected with the first subpixel electrode and the second subpixel electrode of the second pixel electrode.

According to one or more embodiments, a liquid crystal display includes: a first pixel electrode that includes a first subpixel electrode and a second subpixel electrode arranged in a second direction; and a data line that transmits a data voltage, wherein the data line includes a first portion that extends in the second direction outside the first subpixel electrode of the first pixel electrode, a second portion that extends from the first portion in a first direction that intersects the second direction, and a third portion that extends from the second portion in the second direction and overlaps the second subpixel electrode of the first pixel electrode.

The liquid crystal display may further include a second pixel electrode disposed adjacent to the first pixel electrode in the second direction without overlapping the data line.

The liquid crystal display may further include: a common voltage line that extends in the first direction to transmit a common voltage; and a third pixel electrode adjacent to the first pixel electrode in the first direction, wherein the third pixel electrode includes a first subpixel electrode and a second subpixel electrode.

The liquid crystal display may further include a blocking layer that extends in the second direction between the second subpixel electrode of the first pixel electrode and the second subpixel electrode of the third pixel electrode, wherein the common voltage line includes a vertical portion extending in the second direction between the first subpixel electrode of the first pixel electrode and the first subpixel electrode of the third pixel electrode and not between the second subpixel electrode of the first pixel electrode and the second subpixel electrode of the third pixel electrode, and wherein the blocking layer is electrically floated.

The liquid crystal display may further include: a storage electrode disposed along a portion of an edge of the second pixel electrode; and a blocking layer extending in the second direction between the second subpixel electrode of the first pixel electrode and the second subpixel electrode of the third pixel electrode, wherein the common voltage line includes a vertical portion extending in the second direction between the first subpixel electrode of the first pixel electrode and the first subpixel electrode of the third pixel electrode and not between the second subpixel electrode of the first pixel electrode and the second subpixel electrode of the third pixel electrode, and the blocking layer is electrically connected with the storage electrode.

The common voltage line may include a vertical portion extending in the second direction, and the vertical portion of the common voltage line may be disposed between the second subpixel electrode of the first pixel electrode and the second subpixel electrode of the third pixel electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is an equivalent circuit diagram of an exemplary embodiment of a representative pixel of a liquid crystal display constructed according to the principles of the invention.

FIG. 2 is a layout view of a portion of a liquid crystal display constructed according to the principles of the invention.

FIG. 3 is a layout view of two adjacent pixels in an exemplary embodiment of the liquid crystal display of FIG. 2.

FIG. 4 is an enlarged top plan view of a transistor circuit area TA of FIG. 3.

FIG. 5 is a cross-sectional view taken along the line V-V′ of FIG. 3.

FIG. 6 is a cross-sectional view taken along the line VI-VI′ of FIG. 3.

FIG. 7 is a cross-sectional view taken along the line VII-VII′ of FIG. 3.

FIG. 8 is a layout view of two adjacent pixels in another exemplary embodiment of a liquid crystal display constructed according to the principles of the invention.

FIG. 9 is a layout view of two adjacent pixels in still another exemplary embodiment of a liquid crystal display constructed according to the principles of the invention.

FIG. 10 is a cross-sectional view taken along the line X-X′ of FIG. 9.

FIG. 11 is an image that shows transmittance of two adjacent pixels in a liquid crystal display constructed according to the principles of the invention.

FIG. 12 is a gamma graph at the front and side at 60° of liquid crystal displays according to a comparative example and an exemplary embodiment of the invention.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

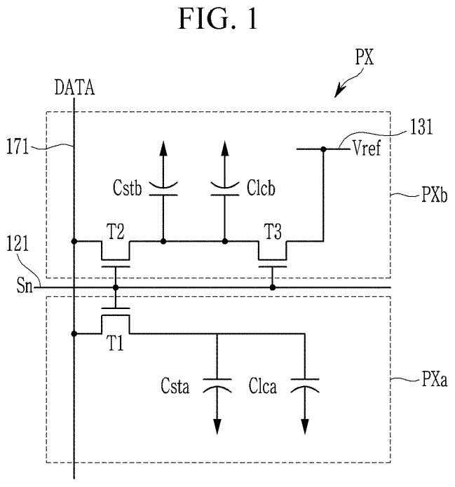

FIG. 1 is an equivalent circuit diagram of an exemplary embodiment of a representative pixel of a liquid crystal display constructed according to the principles of the invention.

Referring to FIG. 1, a pixel PX includes a first subpixel PXa and a second subpixel PXb. The first subpixel PXa includes a first transistor T1 connected to a data line 171 and a gate line 121, a first liquid crystal capacitor Clca, and a first storage capacitor Csta. The first liquid crystal capacitor Clca and the first storage capacitor Csta are connected to the first transistor T1.

The second subpixel PXb includes a second transistor T2 connected to the same data line 171 and the same gate line 121, a third transistor T3 connected to the same gate line 121, and a second liquid crystal capacitor Clcb and the second storage capacitor Cstb connected to the second transistor T2 and the third transistor T3.

The first transistor T1 includes a gate electrode connected to the gate line 121, a source electrode connected to the data line 171, and a drain electrode connected to the first liquid crystal capacitor Clca. The first transistor T1 transmits a data voltage DATA transmitted by the data line 171 to one electrode of the first liquid crystal capacitor Clca by being controlled according to a gate signal Sn transmitted by the gate line 121.

The second transistor T2 includes a gate electrode connected to the same gate line 121, a source electrode connected to the same data line 171, and a drain electrode connected to the second liquid crystal capacitor Clcb and a source electrode of the third transistor T3.

The third transistor T3 includes a gate electrode connected to the same gate line 121, a source electrode connected to the drain electrode of the second transistor T2, and a drain electrode to which a reference voltage Vref is applied.

The first transistor T1, the second transistor T2, and the third transistor T3 are controlled according to the gate signal Sn transmitted by the gate line 121. When the first transistor T1 is turned on by the gate signal Sn, a voltage, which is the difference between a data voltage DATA transmitted through the data line 171 and a common voltage, is charged to the first liquid crystal capacitor Clca. Simultaneously, when the second transistor T2 and the third transistor T3 are turned on by the same gate signal Sn, a middle voltage of the data voltage DATA and the reference voltage Vref may be transmitted to an electrode of the second liquid crystal capacitor Clcb since the electrode of the second liquid crystal capacitor Clcb is connected between the second and third transistors T2 and T3 connected in series between the data line 171 and the node of the reference voltage Vref. That is, a voltage charged to the second liquid crystal capacitor Clcb becomes lower than a voltage charged to the first liquid crystal capacitor Clca.

Since the voltage of the first liquid crystal capacitor Clca and the voltage of the second liquid crystal capacitor Clcb are different from each other, liquid crystal molecules are inclined at different angles in the first subpixel PXa and the second subpixel PXb such that the subpixels PXa and PXb have different luminance.

In general, in a liquid crystal display (LCD), grayscale reversal occurs such that the luminance between the grayscales is reversed, and a gamma curve distortion phenomenon that a front gamma curve and a side gamma curve do not coincide occurs, thereby causing a problem that it exhibits inferior visibility. For example, the image tends to be seen bright and its color tends to be white when the screen is seen from the side, and in severe cases, the luminance difference between bright grayscales is lost and a picture may appear distorted.

However, in the liquid crystal display according to the illustrated exemplary embodiment, luminance of the two subpixels PXa and PXb are different from each other, so that luminance of light viewed from the side may correspond to luminance viewed from the front, and grayscale inversion, which may occur at the side, can be reduced or prevented from occurring, thereby improving side visibility.

The lateral terminals of the first storage capacitor Csta are a pixel electrode of the first subpixel PXa and/or a drain electrode of the first transistor T1 connected thereto, and a first storage electrode of a storage voltage line. In addition, the terminals of the second storage capacitor Cstb are a pixel electrode of the second subpixel PXb and/or a drain electrode of the second transistor T2 connected thereto, and a second storage electrode of the storage voltage line. The first storage capacitor Csta and the second storage capacitor Cstb serve to enhance and maintain storage capabilities of the first liquid crystal capacitor Clca and the second liquid crystal capacitor Clcb. In this case, storage voltages respectively applied to the first storage electrode and the second storage electrode may be the same as the reference voltage Vref. Depending on exemplary embodiments, the liquid crystal display may separately include the storage voltage line and a reference voltage line 131. However, this is not restrictive, and the liquid crystal display may not separately include the storage voltage line, and the first storage electrode, the second storage electrode, and the drain electrode of the third transistor T1 may be connected to the reference voltage line 131.

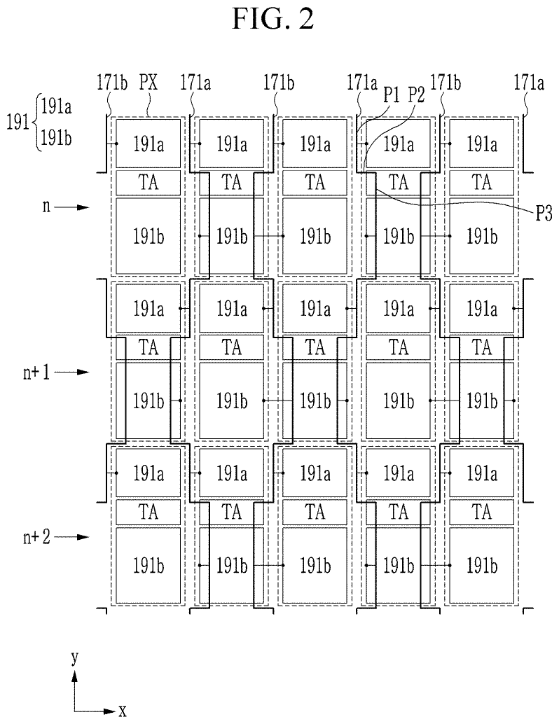

FIG. 2 is a layout view of a portion of a liquid crystal display constructed according to the principles of the invention. The liquid crystal display includes a plurality of pixels PX arranged in a matrix format and a plurality of data lines 171 extending substantially in a column direction (y). Each pixel PX includes a first subpixel electrode 191a, second subpixel electrode 191b, and a transistor circuit area TA where the first to third transistors T1, T2, and T3 of FIG. 1 are disposed.

The first subpixel electrode 191a may include one electrode of the first liquid crystal capacitor Clca of the first subpixel PXa of FIG. 1, and the second subpixel electrode 191b may include one electrode of the second liquid crystal capacitor Clcb of the subpixel PXb. The transistor circuit area TA may be disposed between the first subpixel electrode 191a and the second subpixel electrode 191b.

The data line 171 includes a plurality of angled portions extending from the longitudinal axis of the data line, such as at a right angle (about 90 degrees) to form a data line with staggered sections such that each of the data lines 171a and 171b includes a portion extending in a row direction (x) and a portion extending in the column direction (y). The data line 171 alternately overlaps a second subpixel electrode 191b of a pixel PX disposed at the right side of the data line 171 and a second subpixel electrode 191b of a pixel PX disposed at the left side of the data line 171. The data line 171 may not overlap the first subpixel electrode 191a. In this case, the left side and the right side of the data line 171 refer to a portion where the data line 171 is disposed between the first subpixel electrodes 191a.

The data line 171 includes a first substantially straight portion P1 that does not overlap the first subpixel electrode 191a while extending in the column direction (y) between adjacent first subpixel electrodes 191a, a second angled portion P2 extending from the first straight portion P1 in the row direction (x) between the first subpixel electrode 191a and the second subpixel electrode 191b, and a third substantially straight portion P3 extending from the second angled portion P2 in the column direction (y) while overlapping the second subpixel electrode 191b.

Hereinafter, for better understanding and ease of description, two adjacent data lines 171a and 171b are referred to as a first data line 171a and a second data line 171b, and alignment of the data lines 171 and the pixel electrodes 191 will be described in detail. In this case, if the first data line 171a and the second data line 171b are adjacent to each other, it means that no other data line 171 is disposed between the first data line 171a and the second data line 171b.

The first data lines 171a are disposed between first subpixel electrodes 191a of adjacent pixels PX disposed in an n-th row, and extend substantially in the column direction (y). The first data line 171a is angled to the right side in an area adjacent to a transistor circuit area TA of the pixel PX located in the n-th row, and extends in the column direction (y) while overlapping a second subpixel electrode 191b of the pixel PX located at the right side of the first data line 171a.

The first data line 171a is angled to the left side in an area between the second subpixel electrode 191b of the pixel PX disposed in the n-th row and a first subpixel electrode 191a of a pixel PX disposed in an (n+1)-th row, and extends in the column direction (y) between first subpixel electrodes 191a of adjacent pixels PX disposed in the (n+1)-th row.

The first data line 171a is angled to the left side in an area adjacent to a transistor circuit area TA of the pixel PX located in the (n+1)-th row, and extends in the column direction (y) while overlapping a second subpixel electrode 191b of the pixel PX located at the left side of the first data line 171a.

The first data line 171a is angled to the right side in an area between the second subpixel electrode 191b of the pixel PX disposed in the (n+1)-th row and a first subpixel electrode 191a of a pixel PX disposed in an (n+2)-th row, and extends in the column direction (y) between first subpixel electrodes 191a of adjacent pixels PX disposed in the (n+2)-th row.

The first data line 171a is angled to the right side in an area adjacent to a transistor circuit area TA of the pixel PX located in the (n+2)-th row, and extends in the column direction (y) while overlapping a second subpixel electrode 191b of the pixel PX located at the right side of the first data line 171a.

The second data line 171b substantially extends in the column direction (y) while being adjacent to the first data line 171a.

The second data line 171b extends in the column direction (y) while being disposed between first subpixel electrodes 191a of adjacent pixels PX disposed in the n-th row. The second data line 171b is angled to the left side in an area adjacent to a transistor circuit area TA of the pixel PX located in the n-th row, and extends in the column direction (y) while overlapping a second subpixel electrode 191b of the pixel PX located at the left side of the second data line 171b. In this case, the second subpixel electrode 191b of the pixel PX disposed in the n-th row overlaps both the second data line 171b and the first data line 171a.

The second data line 171b is angled to the right side in an area between the second subpixel electrode 191b of the pixel PX disposed in the n-th row and a first subpixel electrode 191a of a pixel PX disposed in an (n+1)-th row, and extends in the column direction (y) between first subpixel electrodes 191a of adjacent pixels disposed in the (n+1)-th row.

The second data line 171b is angled to the right side in an area adjacent to a transistor circuit area TA of the pixel PX located in the (n+1)-th row, and extends in the column direction (y) while overlapping a second subpixel electrode 191b of the pixel PX located at the right side of the second data line 171b. Thus, the second subpixel electrode 191b of the pixel PX disposed in the (n+1)-th row disposed between the first data line 171a and the second data line 171b does not overlap the first data line 171a and the second data line 171b.

The second data line 171b is angled to the left side in an area between the second subpixel electrode 191b of the pixel PX disposed in the (n+1)-th row and a first subpixel electrode 191a of a pixel PX disposed in the (n+2)-th row, and extends in the column direction (y) between first subpixel electrodes 191a of adjacent pixels PX disposed in the (n+2)-th row.

The second data line 171b is angled to the left side in an area adjacent to a transistor circuit area TA of the pixel PX located in the (n+2)-th row, and extends in the column direction (y) while overlapping a second subpixel electrode 191b of the pixel PX located at the left side of the second data line 171b. In this case, the second subpixel electrode 191b of the pixel PX disposed in the (n+2)-th row overlaps both the second data line 171b and the first data line 171a.

As such, second subpixel electrodes 191b of pixels PX adjacent to and/or surrounding a pixel PX that does not overlap any data line 171 overlap the first and second data lines 171a and 171b. In addition, second subpixel electrodes 191b of pixels PX adjacent to and/or surrounding a pixel PX overlapping the first and second data lines 171a and 171b do not overlap any data line 171. Thus, the subpixel electrodes overlapping the data lines in an alternating fashion in both the row (x) and column (y) direction.

The first data line 171a is electrically connected with a first subpixel electrode 191a and a second subpixel electrode 191b of a pixel PX located at the right side of a first data line 171a in an n-th row. The first data line 171a is electrically connected with a first subpixel electrode 191a and a second subpixel electrode 191b of a pixel PX located at the left side of a first data line 171a in an (n+1)-th row. The first data line 171a is electrically connected with a first subpixel electrode 191a and a second subpixel electrode 191b of a pixel PX located at the right side of a first data line 171a in an (n+2)-th row.

The second data line 171b is electrically connected with a first subpixel electrode 191a and a second subpixel electrode 191b of a pixel PX located at the right side of a second data line 171b in the n-th row. The second data line 171b is electrically connected with a first subpixel electrode 191a and a second subpixel electrode 191b of a pixel PX located at the left side of a second data line 171b in the (n+1)-th row. The second data line 171b is electrically connected with a first subpixel electrode 191a and a second subpixel electrode 191b of a pixel PX located at the right side of a second data line 171b in the (n+2)-th row.

That is, the data line 171 may be alternately electrically connected to the pixel electrode 191 of the pixel PX located at the right side of the data line 171 and the pixel electrode 191 of the pixel PX located at the left side of the data line 171.

As shown in FIG. 2, the liquid crystal display may include a repeated structure of the above-described first data line 171a and second data line 171b.

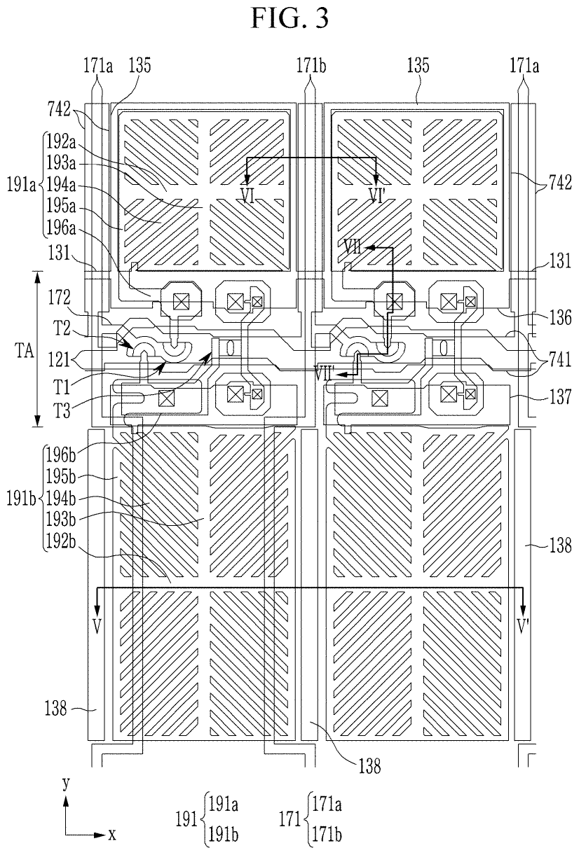

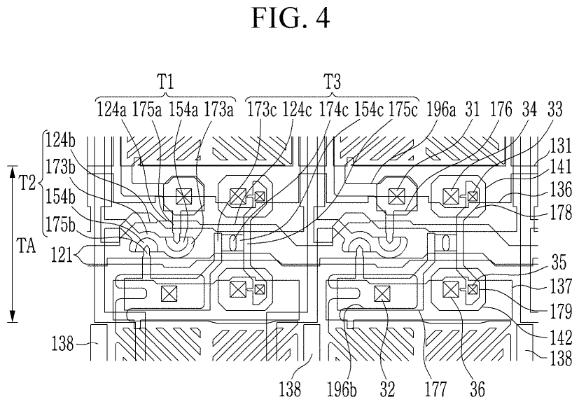

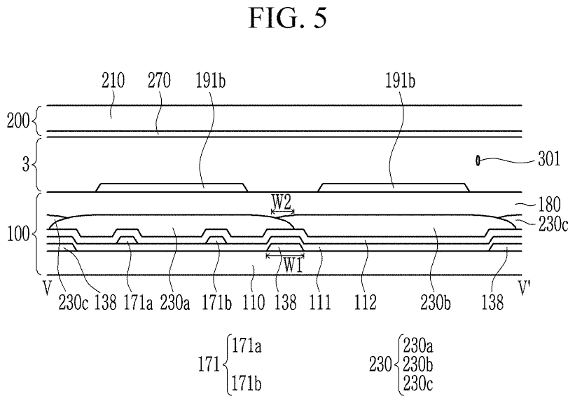

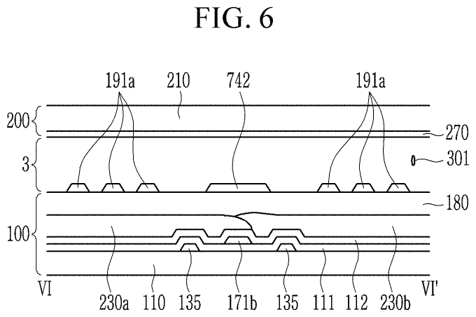

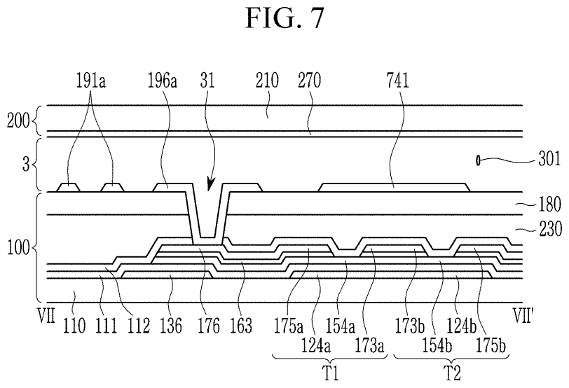

Hereinafter, referring to FIG. 3 to FIG. 7, a pixel of a liquid crystal display according to an exemplary embodiment will be described in detail. FIG. 3 is a layout view of two adjacent pixels in an exemplary embodiment of the liquid crystal display of FIG. 2. FIG. 4 is an enlarged top plan view of a transistor circuit area TA of FIG. 3. FIG. 5 is a cross-sectional view taken along the line V-V′ of FIG. 3. FIG. 6 is a cross-sectional view taken along the line VI-VI′ of FIG. 3.

A liquid crystal display includes a lower display panel 100 and an upper display panel 200 that face each other, and a liquid crystal layer 3 disposed between the two display panels 100 and 200.

First, the lower display panel 100 will be described. The lower display panel 100 includes a plurality of signal lines 121, 131, and 171 and a plurality of transistors T1, T2, and T3.

The lower display panel 100 includes a first substrate 110 made of transparent glass or plastic, and includes gate conductive layers 121, 131, 137, and 138 disposed on the first substrate 110. The gate conductive layers 121, 131, 137, and 138 include a gate line 121 extending in a row direction (x), a reference voltage line 131 extending almost in parallel with the gate line 121 and including a first storage electrode 135, a second storage electrode 137, and a blocking layer 138.

The gate line 121 transmits a gate signal Sn, and includes a first gate electrode 124a, a second gate electrode 124b, and a third gate electrode 124c.

The reference voltage line 131 transmits a reference voltage Vref, and extends in the row direction (x). The reference voltage line 131 includes the first storage electrode 135 that surrounds a first subpixel electrode 191a along an edge of the first subpixel electrode 191a, and includes an expansion portion 136 protruded from the reference voltage line 131. The expansion portion 136 of the reference voltage line 131 is electrically connected with a third drain electrode 175c of a third transistor T3, and the second storage electrode 137. In this case, the reference voltage Vref may be the same as a common voltage or a storage voltage. The reference voltage Vref may be a predetermined constant voltage.

The blocking layer 138 is disposed between second subpixel electrodes 191b that are adjacent to each other in the row direction (x) and extend in the column direction (y). The blocking layer 138 overlaps an area where at least two of first to third color filters 230a, 230b, and 230c, which will be described later, are overlapped with each other, and prevents adjacent colors at boundaries of pixels from being mixed or prevents light from leaking. In this case, a width W1 of the blocking layer 138 may be wider than a width W2 of the area where the at least two of first to third color filters 230a, 230b, and 230c are overlapped with each other.

The blocking layer 138 may have a floated island shape, and may not receive any voltage. The blocking layer 138 may be electrically floated. The blocking layer 138 may include the same material as the gate line 121 and the reference voltage line 131. However, this is not restrictive, and the blocking layer 138 may include a material that is different from that of the gate line 121 and the reference voltage line 131.

A gate insulation layer 111 is disposed on the gate conductive layers that include the gate line 121, the reference voltage line 131, and the blocking layer 138.

A first semiconductor 154a, a second semiconductor 154b, and a third semiconductor 154c are disposed on the gate insulation layer 111.

An ohmic contact 163 is disposed on the semiconductors 154a, 154b, and 154c. However, when the semiconductors 154a, 154b, and 154c are oxide semiconductors, the ohmic contact 163 can be omitted.

Data conductive layers including data line 171 having a first source electrode 173a and a second source electrode 173b, a first drain electrode 175a, a second drain electrode 175b, a third source electrode 173c, an auxiliary electrode 174c, and a third drain electrode 175c are disposed on the ohmic contact 163 and the gate insulation layer 111.

In this case, the data conductive layers 171, 173c, 174c, 175a, 175b, and 175c and the semiconductor 154 and the ohmic contact 163 that are disposed below the data conductive layers may be simultaneously formed by using a single mask. In this case, the data conductive layers 171, 173c, 174c, 175a, 175b, and 175c and the ohmic contact 163 may substantially have the same planar shape.

The data line 171 includes a first data line 171a and a second data line 171b that are adjacent to each other. The first data line 171a is electrically connected to a pixel on the left side of FIG. 3 and transmits a data voltage, and the second data line 171b is electrically connected to a pixel on the right side of FIG. 3 and transmits a data voltage.

The first data line 171a and the second data line 171b extend in a column direction (y) between first subpixel electrodes 191a that are adjacent to each other in a row direction (x). In addition, the first data line 171a and the second data line 171b are angled and extend in the column direction (y) to overlap the same second subpixel electrode 191b. That is, the first data line 171a and the second data line 171b overlap the second subpixel electrode 191b of the left-side pixel of FIG. 3, and a second subpixel electrode 191b of the right-side pixel does not overlap any data line 171.

In case of a liquid crystal display according to a comparative example, the data line 171 may be disposed between second subpixel electrodes 191b rather than overlapping the second subpixel electrode 191b. In this case, vertical crosstalk occurs due to parasitic capacitance between the data line 171 and the second subpixel electrode 191b due to a voltage difference between the data line 171 and the second subpixel electrode 191b. In addition, when the data line 171 is disposed closer to one of the adjacent second subpixel electrodes 191b rather than being disposed in the center of the adjacent second subpixel electrodes 191b, such as may occur due to manufacturing tolerances and the like, the parasitic capacitance between the one of the second subpixel electrode 191b and the data line 171 may be greater than the parasitic capacitance between the other one of the second subpixel electrode 191b such that a luminance difference between adjacent pixels occurs, thereby causing a vertical stain to be viewed.

However, in the liquid crystal display according to the illustrated exemplary embodiment, the second subpixel electrode 191b may overlap two data lines 171a and 171b or may not overlap any data line 171 in order to reduce or prevent vertical stain caused by the luminance difference due to a parasitic capacitance difference from being generated when the data line 171 is located closer to one of the adjacent pixels.

In this case, luminance of the second subpixel PXb that overlaps two data lines 171a and 171b may be lower than luminance of the second subpixel PXb that does not overlap any data line 171. In the liquid crystal display according to the illustrated exemplary embodiment, pixels that are adjacent to pixels overlapped with two data lines 171a and 171b in the row direction (x) and the column direction (y) do not overlap any data line 171, and pixels that are adjacent to pixels not-overlapped with two data lines 171a and 171b in the row direction (x) and the column direction (y) overlap two data lines 171a and 171b such that areas having high luminance and areas having low luminance have a lattice structure. Lattice stains caused by the high luminance areas and the low luminance areas are significantly less visible than vertical stains. Thus, the data lines 171 disposed as in the illustrated exemplary embodiment may enable the liquid crystal display to generate invisible and/or less visible lattice stains, but may reduce or altogether prevent vertical staining due to the difference in parasitic capacitance between the data line 171 and the pixel electrode 191.

The first source electrode 173a and the first drain electrode 175a form a single first transistor (e.g., Thin-Film Transistor: TFT) T1 together with the first semiconductor 154a, and a channel of the first transistor T1 is formed in the first semiconductor 154a between the first source electrode 173a and the first drain electrode 175a. One end of the first drain electrode 175a includes a widely expanded first expansion portion 176.

The second gate electrode 124b, the second source electrode 173b, and the second drain electrode 175b form a single second transistor T2 together with the second semiconductor 154b, and a channel of the second transistor T2 is formed in the second semiconductor 154b between the second source electrode 173b and the second drain electrode 175b. The second drain electrode 175b is connected with the third source electrode 173c, and includes a widely expanded second expansion portion 177.

The third gate electrode 124c, the third source electrode 173c, the auxiliary electrode 174c, and the third drain electrode 175c form a single third transistor (or a voltage-dividing transistor) T3, and a channel of the third transistor T3 is formed in the third semiconductor 154c between the third source electrode 173c and the third drain electrode 175c.

The auxiliary electrode 174c is an island type, and overlaps the third semiconductor 154c and the third gate electrode 124c. A width or a length of the channel of the third transistor T3 can be adjusted by the auxiliary electrode 174c, and degradation and/or deterioration of the third transistor T3 can be prevented. One end of the third drain electrode 175c includes an extended first connection portion 178, which is connected with a first connection member 141 through an opening 33, and the first connection member 141 is connected to an expansion portion 136 of a reference voltage line 131 through an opening 34. The other end of the third drain electrode 175c includes an extended second connection portion 179, which is connected with a second connection member 142 through an opening 35, and the second connection member 142 is connected to a second storage electrode 137 through an opening 36. That is, the first storage electrode 135 and the second storage electrode 137 are electrically connected with the reference voltage line 131 and thus receive a reference voltage Vref. However, unlike the illustrated embodiment, the first storage electrode 135 and the second storage electrode 137 may be connected to separate storage electrode lines.

An inorganic insulation layer 112 is disposed on the data conductive layers 171, 173c, 174c, 175a, 175b, and 175c and exposed portions of the semiconductors 154a, 154b, and 154c. The inorganic insulation layer 112 may include a silicon nitride or a silicon oxide. The inorganic insulation layer 112 can prevent a pigment of a color filter 230 from being introduced through the exposed portions of the semiconductors 154a, 154b, and 154c.

A color filter 230 is disposed on the inorganic insulation layer 112. The color filter 230 extends in a vertical direction along two adjacent data lines 171a and 171b. The color filter 230 may include a first color filter 230a, a second color filter 230b, and a third color filter 230c. The first color filter 230a, the second color filter 230b, and the third color filter 230c may have different basic colors. For example, the first color filter 230a may be a red color filter, the second color filter 230b may be a green color filter, and the third color filter 230c may be a blue color filter. Depending on exemplary embodiments, the liquid crystal display may include a color conversion layer rather than the color filter 230. The color conversion layer includes quantum dots or scatterers, and may convert incident light to light having a specific color.

A passivation layer 180 may be disposed on the color filter 230. An opening 31 exposing the first drain electrode 175a and an opening 32 exposing the second drain electrode 175b are disposed in the inorganic insulation layer 112 and the passivation layer 180.

Pixel electrodes 191 and common voltage lines 741 and 742 are disposed on the passivation layer 180. Each pixel electrode 191 includes a first subpixel electrode 191a and a second subpixel electrode 191b that are separated from each other while disposing the gate line 121 therebetween, and neighbor each other in the column direction y with reference to the gate line 121. The pixel electrode 191 may be formed of a transparent material such as an ITO and an IZO. The pixel electrode 191 may be formed of a reflective metallic material such as aluminum, silver, chromium, or an alloy thereof.

The first subpixel electrode 191a may include a cross-shaped stem portion that includes a horizontal stem portion 192a and a vertical stem portion 193a, a plurality of branch portions 194a extending to the outside from the cross-shaped stem portion, an edge portion 195a that defines an outer edge, and an expansion portion 196a connected with the first drain electrode 175a. The second subpixel electrode 191b may include a cross-shaped stem portion that includes a horizontal stem portion 192b and a vertical stem portion 193b, a plurality of branch portions 194b extending to the outside from the cross-shaped stem portion, an edge portion 195b that defines an outer edge, and an expansion portion 196b connected with the second drain electrode 175b. A planar area of the first subpixel electrode 191a may be smaller than that of the second subpixel electrode 191b.

The common voltage lines 741 and 742 include a horizontal portion 741 extended in the row direction (x) and a vertical portion 742 extended in the column direction (y), and the common voltage lines 741 and 742 transmit a common voltage. The vertical portion 742 of the common voltage line extends in the column direction (y) between first subpixel electrodes 191a that are adjacent to each other in the row direction (x). In the liquid crystal display according to the illustrated exemplary embodiment, the vertical portion 742 of the common voltage line is not disposed between second subpixel electrodes 191b that are adjacent to each other in the row direction (x). Thus, no design margin between the common voltage lines 741 and 742 and the second subpixel electrodes 191b that are disposed on the same layer such as the passivation layer 180 is required, thereby increasing an aperture ratio and transmittance of the pixel.

The first subpixel electrode 191a and the second subpixel electrode 191b are physically and electrically connected with the first drain electrode 175a and the second drain electrode 175b through the openings 31 and 32, and receive a data voltage from the first drain electrode 175a and the second drain electrode 175b. In this case, some of the data voltage applied to the second drain electrode 175b is divided by the third source electrode 173c, and thus the voltage applied to the first subpixel electrode 191a is higher than the voltage applied to the second subpixel electrode 191b.

The first subpixel electrode 191a and the second subpixel electrode 191b that are applied with the data voltage generate an electric field together with a common electrode 270 of the upper display panel 200 such that a direction of liquid crystal molecules 301 of the liquid crystal layer 3 between the two electrodes 191 and 270 is adjusted. Luminance of light transmitted through the liquid crystal layer 3 is changed depending on the direction of the liquid crystal molecules 301 adjusted as described above.

A lower alignment layer may be disposed on the pixel electrode 191 and the common voltage lines 741 and 742, and the lower alignment layer may be a vertical alignment layer.

Hereinafter, the upper display panel 200 will be described.

The upper display panel 200 includes a second substrate 210 formed of transparent glass or plastic.

The common electrode 270 is disposed below the second substrate 210. An upper alignment layer may be disposed below the common electrode 270, and the upper alignment layer may be a vertical alignment layer.

The liquid crystal layer 3 has negative dielectric anisotropy, and liquid crystal molecules 301 of the liquid crystal layer 3 are aligned such that their long axes are perpendicular to the surfaces of the two display panel 100 and 200 while no electric field is present.

The liquid crystal display may further include a pair of polarizers that are attached to the outside of the two display panels 100 and 200 or disposed inside the two display panels 100 and 200. In this case, transmissive axes of the two polarizers may be perpendicular to each other.

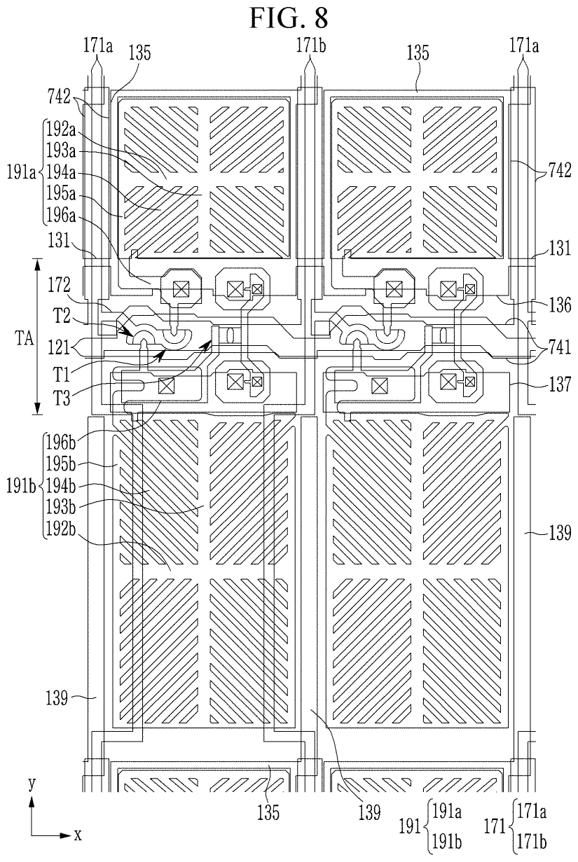

Hereinafter, referring to FIG. 8, a liquid crystal display according to another exemplary embodiment will be described. FIG. 8 is a layout view of two adjacent pixels in another exemplary embodiment of a liquid crystal display constructed according to the principles of the invention. Except for a blocking layer 139, the liquid crystal display of FIG. 8 is similar to the liquid crystal display of FIG. 3, and therefore duplicated descriptions will be omitted to avoid redundancy.

Referring to FIG. 8, a liquid crystal display include a blocking layer 139 that extends in a column direction (y) between second subpixel electrodes 191b that are adjacent to each other in a row direction (x). The blocking layer 139 overlaps an area where at least two of the first to third color filters 230a, 230b, and 230c are overlapped with each other, and prevents colors that are adjacent to each other at a pixel boundary from being mixed or prevents light leakage. In addition, the blocking layer 139 is connected with a first storage electrode 135 that overlaps a first subpixel electrode 191a of a pixel that is adjacent in a column direction (y) and receives a reference voltage Vref. Unlike the liquid crystal display of the blocking layer 138 of FIG. 3, the blocking layer 139 may be connected with the first storage electrode 135 and receive the reference voltage Vref and overlap the first subpixel electrode 191a, thereby further reinforcing sustainability of a first liquid crystal capacitor Clca.

However, this is not restrictive, and depending on exemplary embodiments, the liquid crystal display may further include a separate storage electrode line connected with the first storage electrode 135, and the blocking layer 139 may be connected with the first storage electrode 135 and receive a storage voltage.

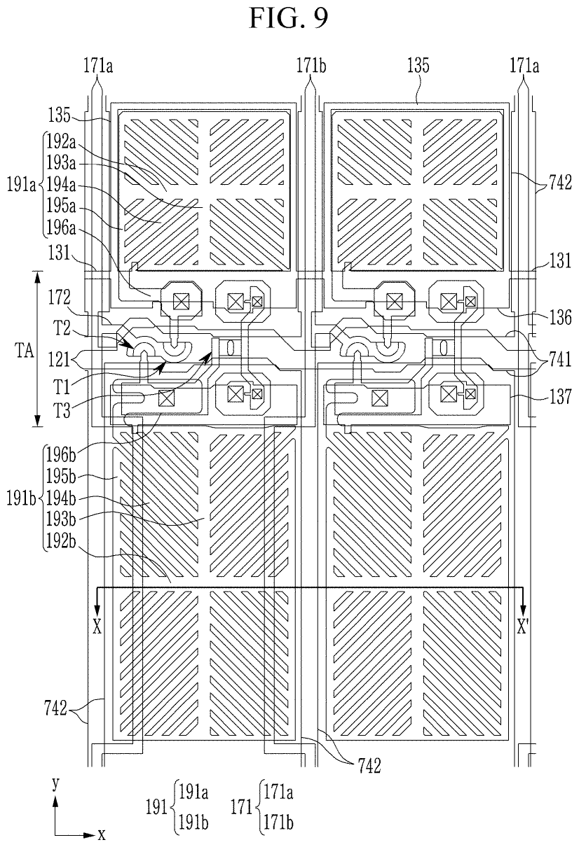

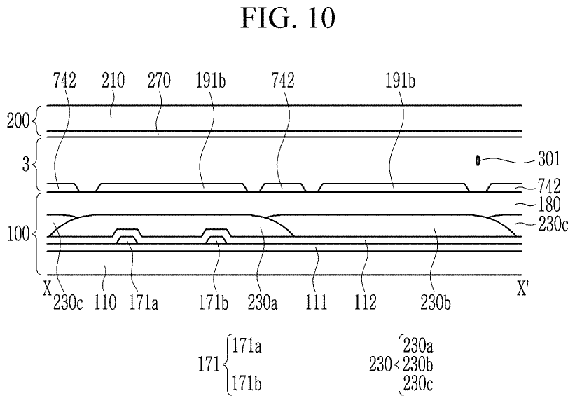

Hereinafter, a liquid display device according to another exemplary embodiment will be described with reference to FIG. 9 and FIG. 10. FIG. 9 is a layout view of two adjacent pixels in still another exemplary embodiment of a liquid crystal display constructed according to the principles of the invention. FIG. 10 is a cross-sectional view taken along the line X-X′ of FIG. 9.

Referring to FIG. 9 and FIG. 10, a vertical portion 742 of a common voltage line extends in a column direction (y) between pixels. The vertical portion 742 of the common voltage line is also disposed between second subpixel electrodes 191b that are adjacent to each other in a row direction (x). The transistor circuit area TA of the liquid crystal display is connected via the vertical portion 742 as well as the horizontal portion 741 of the common voltage line to form a mesh structure. Thus, a voltage drop of a common voltage in a center portion of the liquid crystal display can be prevented.

In addition, the vertical portion 742 of the common voltage line may overlap an overlapped portion of at least two of the first to third color filters 230a, 230b, and 230c and prevents mixture of adjacent colors or light leakage.

Hereinafter, an effect of improving the aperture ratio, transmittance, and side visibility without having a vertical stain observed in a liquid crystal display (LCD) according to an exemplary embodiment will be described.

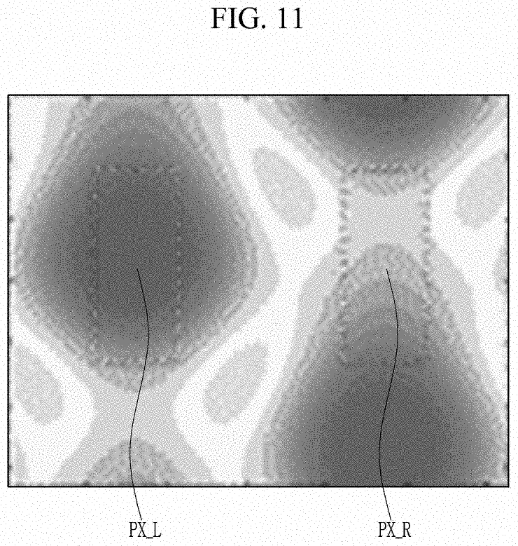

FIG. 11 is an image that shows transmittance of two adjacent pixels in a liquid crystal display constructed according to the principles of the invention. Referring to FIG. 11, the liquid crystal display includes a pixel PX_R that overlaps two data lines and a pixel PX_L that does not overlap any data line. Hereinafter, the pixel PX_R that overlaps two data lines is referred to as an overlapping pixel and the pixel PX_L that does not overlap any data line is referred to as a non-overlapping pixel.

Pixels PX disposed in the same row include overlapping pixels and non-overlapping pixels that are alternately disposed, and pixels PX disposed in the same column include overlapping pixels and non-overlapping pixels that are alternately disposed. Pixels that are adjacent to the overlapping pixel in the row direction or the column direction may all be non-overlapping pixels, and pixels that are adjacent to the non-overlapping pixels in the row direction or the column direction may all be overlapping pixels. The overlapping pixel overlaps two data lines, and thus has lower luminance than the non-overlapping pixel that does not overlap a data line. Thus, in the liquid crystal display according to the illustrated exemplary embodiment, as shown in FIG. 11, a pixel area having higher luminance and a pixel area having lower luminance are arranged in a lattice format.

When the high luminance area and the low luminance area are arranged in a lattice format, stains caused by luminance differences are not well visible to a user as compared with the case where the high luminance area is linearly displayed. Also, in the liquid crystal display according to the illustrated exemplary embodiment, since the data line does not overlap with a first subpixel electrode, a luminance difference between the overlapping pixel and the non-overlapping pixel is not large enough to be seen by the user.

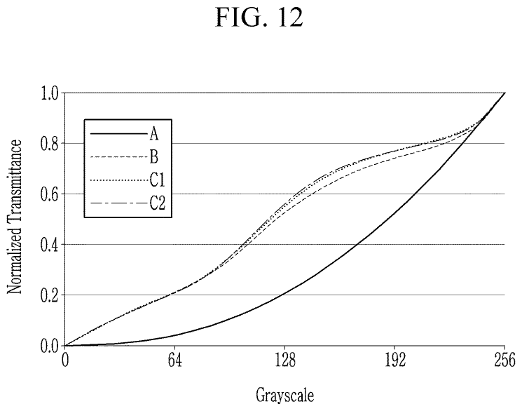

Hereinafter, referring to FIG. 12 and Table 1, an aperture ratio, transmittance, and a gamma distortion index (GDI) of a liquid crystal display according to an exemplary embodiment will be described. FIG. 12 is a gamma graph at the front and side at 60° of liquid crystal displays according to a comparative example and an exemplary embodiment of the invention.

In the graph of FIG. 12, the horizontal axis denotes grayscales and the vertical axis denotes normalized transmittance. A represents transmittance at the front. B represents transmittance when viewing one pixel of the liquid crystal display (LCD) at a side view of 60 degrees)(° according to a comparative example including a data line that extends in a straight line so that the data line does not overlap with the second subpixel electrodes. In this manner, a common voltage line may be located between the second subpixel electrodes. C1 and C2 represent transmittance mean values at the side view of 60° of an overlapping pixel and a non-overlapping pixel that are adjacent to each other in the liquid crystal display according to the exemplary embodiment of FIG. 3. C1 is a case that a width of the blocking layer 138 of FIG. 3 is 5 μm, and C2 is a case that a width of the blocking layer 138 of FIG. 3 is 6 μm.

Table 1 shows aperture ratios, transmittance, and gamma distortion indexes (GDI) of the pixels of the liquid crystal display according to the comparative example (B) and the exemplary embodiments (C1 and C2).

TABLE 1

| | B | C1 | C2 |
|---|---|---|---|
| Transmittance | 100% | 109% | 108% |
| Aperture ratio | 100.0% | 105.4% | 104.6% |
| Visibility index (GDI) | 0.313 | 0.309 | 0.309 |

Referring to FIG. 12 and Table 1, it can be observed that the transmittance and the aperture ratio of the exemplary embodiments (C1 and C2) are increased compared to the comparative example (B). In addition, the gamma distortion index (GDI) is decreased such that side visibility is also improved. Here, the gamma distortion index (GDI) is a numerical value of the side view visibility, and the smaller the value, the better the lateral (i.e., side) visibility.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A liquid crystal display comprising:
a plurality of pixel electrodes; and
a first data line and a second data line, each of the first data line and the second data line configured to transmit a data voltage and having substantially straight and angled portions,
wherein:
the first data line and the second data line are adjacent to each other in a first direction,
the plurality of pixel electrodes comprises:
a first pixel electrode that overlaps both the first data line and the second data line; and
a second pixel electrode disposed adjacent to the first pixel electrode in a second direction that intersects the first direction without overlapping the first data line and the second data line.

2. The liquid crystal display of claim 1, further comprising a third data line adjacent to the second data line in the first direction,
wherein the plurality of pixel electrodes further comprises a third pixel electrode disposed adjacent to the first pixel electrode in the first direction without overlapping any of the first data line, the second data line, and the third data line.

3. The liquid crystal display of claim 2, wherein the plurality of pixel electrodes further comprises a fourth pixel electrode adjacent to the second pixel electrode in the first direction and adjacent to the third pixel electrode in the second direction, and
wherein the fourth pixel electrode overlaps both the second data line and the third data line.

4. The liquid crystal display of claim 3, wherein each of the first pixel electrode, the second pixel electrode, the third pixel electrode, and the fourth pixel electrode comprises:
a first subpixel electrode connected with a first transistor; and
a second subpixel electrode connected with a second transistor and a third transistor, and
wherein the second data line extends in the second direction between the first subpixel electrode of the first pixel electrode and the first subpixel electrode of the third pixel electrode, and is angled to overlap second subpixel electrode of the first pixel electrode.

5. The liquid crystal display of claim 4, wherein the second data line extends in the second direction between the first subpixel electrode of the second pixel electrode and the first subpixel electrode of the fourth pixel electrode, and is angled to overlap the second subpixel electrode of the fourth pixel electrode.

6. The liquid crystal display of claim 5, wherein the third data line extends in the second direction while overlapping the second subpixel electrode of the fourth pixel electrode.

7. The liquid crystal display of claim 4, further comprising:
a common voltage line that extends in the first direction and transmits a common voltage; and
a reference voltage line that extends in the first direction and transmits a reference voltage,
wherein the reference voltage line is connected with the third transistor.

8. The liquid crystal display of claim 7, further comprising a blocking layer that extends in the second direction between the second subpixel electrode of the first pixel electrode and the second subpixel electrode of the third pixel electrode,
wherein the common voltage line comprises a vertical portion extending in the second direction between the first subpixel electrode of the first pixel electrode and the first subpixel electrode of the third pixel electrode and not between the second subpixel electrode of the first pixel electrode and the second subpixel electrode of the third pixel electrode.

9. The liquid crystal display of claim 8, wherein the blocking layer is electrically floated.

10. The liquid crystal display of claim 8, wherein the blocking layer is electrically connected with the reference voltage line and receives the reference voltage.

11. The liquid crystal display of claim 8, further comprising a first color filter that overlaps the first pixel electrode and a second color filter that overlaps the third pixel electrode,
wherein the blocking layer overlaps an area where the first color filter and the second color filter overlap each other, and
wherein a width of the blocking layer is wider than a width of the area where the first color filter and the second color filter overlap each other.

12. The liquid crystal display of claim 7, wherein the common voltage line comprises a vertical portion extending in the second direction, and
the vertical portion of the common voltage line is disposed between the second subpixel electrode of the first pixel and the second subpixel electrode of the third pixel electrode.

13. The liquid crystal display of claim 6, wherein the first data line is electrically connected with the first subpixel electrode and the second subpixel electrode of the first pixel electrode, and
the second data line is electrically connected with the first subpixel electrode and the second subpixel electrode of the third pixel electrode.

14. The liquid crystal display of claim 13, wherein the second data line is electrically connected with the first subpixel electrode and the second subpixel electrode of the second pixel electrode.

15. A liquid crystal display comprising:
a first pixel electrode that includes a first subpixel electrode and a second subpixel electrode arranged in a second direction; and
a data line that transmits a data voltage,
wherein the data line comprises a first portion that extends in the second direction outside the first subpixel electrode of the first pixel electrode, a second portion that extends from the first portion in a first direction that intersects the second direction, and a third portion that extends from the second portion in the second direction and overlaps the second subpixel electrode of the first pixel electrode.

16. The liquid crystal display of claim 15, further comprising a second pixel electrode disposed adjacent to the first pixel electrode in the second direction without overlapping the data line.

17. The liquid crystal display of claim 16, further comprising:
a common voltage line that extends in the first direction to transmit a common voltage; and
a third pixel electrode adjacent to the first pixel electrode in the first direction,
wherein the third pixel electrode comprises a first subpixel electrode and a second subpixel electrode.

18. The liquid crystal display of claim 17, further comprising a blocking layer that extends in the second direction between the second subpixel electrode of the first pixel electrode and the second subpixel electrode of the third pixel electrode,
wherein the common voltage line comprises a vertical portion extending in the second direction between the first subpixel electrode of the first pixel electrode and the first subpixel electrode of the third pixel electrode and not between the second subpixel electrode of the first pixel electrode and the second subpixel electrode of the third pixel electrode, and
wherein the blocking layer is electrically floated.

19. The liquid crystal display of claim 17, further comprising:
a storage electrode disposed along a portion of an edge of the second pixel electrode; and
a blocking layer extending in the second direction between the second subpixel electrode of the first pixel electrode and the second subpixel electrode of the third pixel electrode,
wherein the common voltage line comprises a vertical portion extending in the second direction between the first subpixel electrode of the first pixel electrode and the first subpixel electrode of the third pixel electrode and not between the second subpixel electrode of the first pixel electrode and the second subpixel electrode of the third pixel electrode, and
the blocking layer is electrically connected with the storage electrode.

20. The liquid crystal display of claim 17, wherein the common voltage line comprises a vertical portion extending in the second direction, and
the vertical portion of the common voltage line is disposed between the second subpixel electrode of the first pixel electrode and the second subpixel electrode of the third pixel electrode.
